(19) United States
(12) Patent Application Publication
(10) Pub. No.: US 2015/0009876 A1
(43) Pub. Date: Jan. 8, 2015

(54) COMMUNICATION SYSTEM WITH RADIO INTERWORKING CAPABILITY AND RELATED COMMUNICATION STATION AND USER EQUIPMENT

(71) Applicant: ACER INCORPORATED, New Taipei City (TW)

(72) Inventor: Shiang-Rung YE, New Taipei City (TW)

(21) Appl. No.: 14/316,501

(22) Filed: Jun. 26, 2014

Related U.S. Application Data
(60) Provisional application No. 61/843,212, filed on Jul. 5, 2013.
(60) Provisional application No. 61/857,167, filed on Jul. 22, 2013.

(51) Int. Cl. H04W 52/02; H04W 48/16

(52) U.S. Cl. CPC H04W 52/0209; H04W 48/16
USPC 370/311

(57) ABSTRACT

A communication system includes a communication station, multiple access points, and a user equipment. The communication station transmits signal by utilizing a first radio access technology, stores a target frequency list utilized for representing multiple target frequencies, and transmits the target frequency list and an assigned scanning order. The user equipment receives the target frequency list and the assigned scanning order transmitted from the transceiving circuit by utilizing the first RAT, and scans the multiple target frequencies in order according to the assigned scanning order to locate an available access point.

### CROSS-REFERENCE TO RELATED APPLICATIONS

This application claims the benefit of priority to U.S. Provisional Application Ser. No. 61/843,212, filed on Jul. 5, 2013; the entirety of which is incorporated herein by reference for all purposes.

This application claims the benefit of priority to U.S. Provisional Application Ser. No. 61/857,167, filed on Jul. 22, 2013; the entirety of which is incorporated herein by reference for all purposes.

### BACKGROUND

The disclosure generally relates to a communication system and, more particularly, to a communication system with radio interworking capability and related communication station and user equipment.

A base station of a mobile communication network is only capable of communicating with a certain number of user equipments within a certain wireless transmission range. Therefore, many technologies have been developed to increase the amount of user equipments that can be served in a certain area, to balance the load in the mobile communication network, to improve the communication quality, etc. For example, the traditional mobile communication network may adopt a radio interworking mechanism to provide both the 3GPP radio access resources and the wireless local area network (abbreviated as WLAN) radio access resources at the same time so as to improve the system performance.

Under the traditional radio interworking mechanism, the user equipment has to blindly scan different frequencies in order to locate available WLANs, but the mobile communication network operator may not deploy WLANs on all available frequencies. Therefore, the user equipment often spends too much battery power on unnecessary scanning of WLANs. It is apparently that the traditional radio interworking mechanism adversely affects the power saving performance for the user equipment operating in the mobile communication network.

### SUMMARY

In view of the foregoing, it may be appreciated that a substantial need exists for apparatuses that mitigate or reduce the problems above.

An example embodiment of a communication system is disclosed, comprising: a communication station, comprising: a transceiving circuit configured to operably transmit signal by utilizing a first radio access technology; a storage device configured to operably store a target frequency list, wherein the target frequency list is utilized for representing multiple target frequencies comprising a first target frequency and a second target frequency; and a processor module, coupled with the transceiving circuit and the storage device, configured to operably control the transceiving circuit to transmit the target frequency list and an assigned scanning order, wherein the assigned scanning order prioritizes the first target frequency to be right prior to the second target frequency; multiple access points comprising a first access point; and a user equipment, comprising: a first communication circuit configured to operably receive the target frequency list and the assigned scanning order transmitted from the transceiving circuit by utilizing the first RAT; a second communication circuit configured to operably communicate with other devices by utilizing a second RAT different from the first RAT; a memory device configured to operably store the target frequency list and the assigned scanning order received by the first communication circuit; and a control circuit, coupled with the first communication circuit, the second communication circuit, and the memory device, configured to operably control the second communication circuit to scan the multiple target frequencies in order according to the assigned scanning order to locate an available access point.

Another example embodiment of a communication station of a communication system is disclosed. The communication system comprises multiple access points and a user equipment. The communication station comprises: a transceiving circuit configured to operably transmit signal by utilizing a first radio access technology; a storage device configured to operably store a target frequency list, wherein the target frequency list is utilized for representing multiple target frequencies comprising a first target frequency and a second target frequency; and a processor module, coupled with the transceiving circuit and the storage device, configured to operably control the transceiving circuit to transmit the target frequency list and an assigned scanning order to the user equipment to enable the user equipment to scan the multiple target frequencies in order according to the assigned scanning order to locate an available access point; wherein the assigned scanning order prioritizes the first target frequency to be right prior to the second target frequency.

Another example embodiment of a user equipment of a communication system is disclosed. The communication system comprises a communication station and multiple access points. The user equipment comprises: a first communication circuit configured to operably receive a target frequency list and an assigned scanning order transmitted from the communication station by utilizing a first radio access technology, wherein the target frequency list is utilized for representing multiple target frequencies comprising a first target frequency and a second target frequency, and the assigned scanning order prioritizes the first target frequency to be right prior to the second target frequency; a second communication circuit configured to operably communicate with other devices by utilizing a second RAT different from the first RAT; a memory device configured to operably store the target frequency list and the assigned scanning order received by the first communication circuit; and a control circuit, coupled with the first communication circuit, the second communication circuit, and the memory device, configured to operably control the second communication circuit to scan the multiple target frequencies in order according to the assigned scanning order to locate an available access point.

Both the foregoing general description and the following detailed description are examples and explanatory only, and are not restrictive of the invention as claimed.

### BRIEF DESCRIPTION OF THE DRAWINGS

FIG. 1 shows a simplified schematic diagram of a communication system according to one embodiment of the present disclosure.

FIG. 2 shows a simplified functional block diagram of some member device in the communication system of FIG. 1 according to one embodiment of the present disclosure.

FIG. 3 shows a simplified schematic diagram of a beacon frame containing substitutable frequency indication message according to one embodiment of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

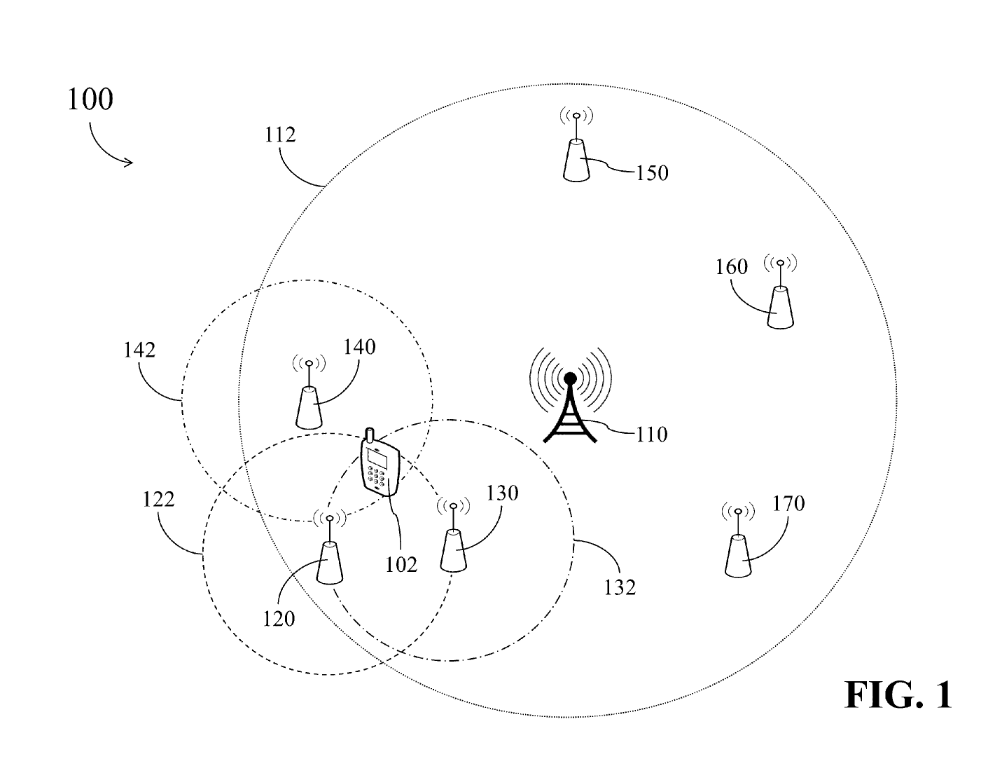

FIG. 1 shows a simplified schematic diagram of a communication system 100 according to one embodiment of the present disclosure. In this embodiment, the communication system 100 comprises a user equipment 102, a communication station 110, and multiple access points (for example, access points 120-170 shown in FIG. 1). As shown in FIG. 1, the communication station 110 has a wireless transmission range 112, the access point 120 has a wireless transmission range 122, the access point 130 has a wireless transmission range 132, and the access point 140 has a wireless transmission range 142. In addition, some of the access points 120-170 are the neighboring access points to one another. In this embodiment, for example, the wireless transmission range 122 of the access point 120 overlaps the wireless transmission range 132 of the access point 130 and the wireless transmission range 142 of the access point 140.

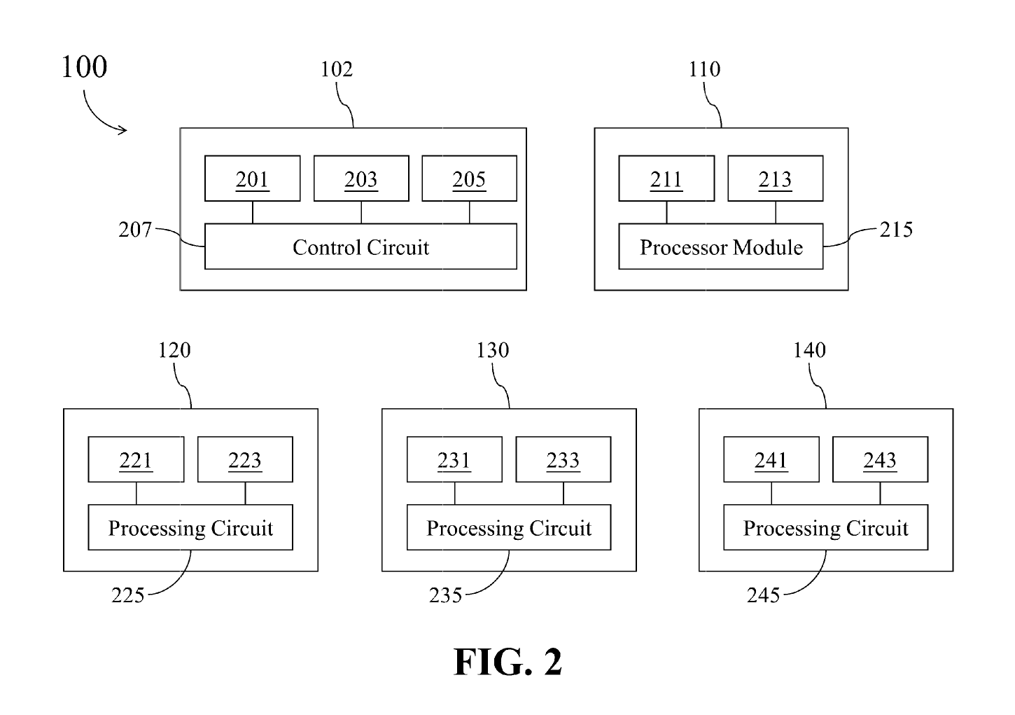

FIG. 2 shows a simplified functional block diagram of some member device in the communication system 100 of FIG. 1 according to one embodiment of the present disclosure. As shown in FIG. 2, the equipment 102 comprises a first communication circuit 201, a second communication circuit 203, a memory device 205, and a control circuit 207. The communication station 110 comprises a transceiving circuit 211, a storage device 213, and a processor module 215. Each of the access points 120-170 comprises a transmission circuit, an AP memory, and a processing circuit. For example, the access point 120 comprises a transmission circuit 221, an AP memory 223, and a processing circuit 225; the access point 130 comprises a transmission circuit 231, an AP memory 233, and a processing circuit 235; the access point 140 comprises a transmission circuit 241, an AP memory 243, and a processing circuit 245; and so forth.

In the communication station 110, the transceiving circuit 211 is configured to operably transmit signal by utilizing a first radio access technology (abbreviated as RAT). The storage device 213 is configured to operably store a target frequency list. The processor module 215 is coupled with the transceiving circuit 211 and the storage device 213. The processor module 215 is configured to operably generate the target frequency list and an assigned scanning order, and to operably control the transceiving circuit 211 to transmit the target frequency list and the assigned scanning order.

In the user equipment 102, the first communication circuit 201 is configured to operably receive the target frequency list and the assigned scanning order transmitted from the transceiving circuit 211 by utilizing the first RAT. The second communication circuit 203 is configured to operably communicate with other devices (e.g., one or more access points) by utilizing a second RAT different from the first RAT. The memory device 205 is configured to operably store the target frequency list and the assigned scanning order received by the first communication circuit 201. The control circuit 207 is coupled with the first communication circuit 201, the second communication circuit 203, and the memory device 205. The control circuit 207 is configured to operably control the second communication circuit 203 to scan multiple target frequencies indicated by the target frequency list in order according to the assigned scanning order to locate an available access point.

In each of the access points 120-170, the transmission circuit is configured to operably communicate with the user equipment 102 by utilizing the second RAT. In some embodiments, the AP memory is configured to operably store a substitutable frequency indication message. The processing circuit is coupled with the transmission circuit and the AP memory. In some embodiments, the processing circuit may be configured to operably control the transmission circuit to transmit the substitutable frequency indication message to the second communication circuit 203 of the user equipment 102 if a wireless link between the user equipment 102 and the access point is established.

The term “target frequency list” as used throughout the description and the claims refers to any appropriate information utilized for representing multiple target frequencies F1-Fn on which available WLANs (wireless local area networks) are deployed by the operator of the communication system 100 or deployed by the partners of the operator. The term “assigned scanning order” as used throughout the description and the claims refers to any appropriate indication information utilized for informing a user equipment of that the multiple target frequencies derived from the target frequency list should be scanned in a predetermined order configured by the operator of the communication system 100. For example, the assigned scanning order may prioritize a first target frequency F1 to be right prior to a second target frequency F2. In other words, the second target frequency F2 is prioritized right behind the first target frequency F1 in the assigned scanning order.

The term “substitutable frequency indication message” as used throughout the description and the claims refers to any appropriate message utilized for representing one or more substitutable frequencies on which some other available WLANs are deployed. In practice, the one or more substitutable frequencies may include the frequencies supported by nearby access points or may include other frequencies supported by the same access point.

In practice, each of the transceiving circuit 211 and the first communication circuit 201 may comprise one or more antennas, one or more modulators/demodulators, one or more analog signal processing circuits, and/or one or more digital processing circuits for communicating with other devices by utilizing the first RAT. Each of the second communication circuit 203 and the transmission circuit of each of the access points 120-170 may comprise one or more antennas, one or more modulators/demodulators, one or more analog signal processing circuits, and/or one or more digital processing circuits for communicating with other devices by utilizing the second RAT.

Each of the storage device 213, the memory device 205, and the AP memory of each of the access points 120-170 may be realized with one or more volatile/non-volatile memory circuits, such as registers, hard drives, or flash memory devices.

Each of the processor module 215, the control circuit 207, and the processing circuit of each of the access points 120-170 may be realized with one or more microprocessors, one or more network processors, one or more digital signal processing circuits, and/or other suitable processing circuits.

For the purposes of conciseness and clear explanation, some components and connections of the communication system 100 are not shown in FIG. 1.

As can be appreciated from the foregoing descriptions, the user equipment 102 is capable of communicating with the communication station 110 adopting the first RAT while communicating with an available access point adopting the second RAT. In practice, the first RAT may refer to one or more wireless wide area network (abbreviated as WWAN) technologies, wireless metropolitan area network (abbreviated as WMAN) technologies, or other suitable wire communication technologies with a wider communication range, such as WiMAX, GSM, UMTS, HSPA, LTE, LTE-Advanced and other 3GPP RATs. The second RAT may refer to one or more WLANs technologies, or other suitable wire communication technologies with a shorter communication range (compared with the first RAT), such as IEEE 802.11 series RATs.

For the illustrative purpose, it is assumed hereinafter that the first RAT is referred to at least one of the 3GPP RATs and the second RAT is referred to at least one of the IEEE 802.11 series RATs. Thus, the communication station 110 may be realized with a 3GPP base station (abbreviated as BS), such as a Node B or an Evolved Node B (abbreviated as eNodeB or eNB). In addition, each of the access points 120-170 may be realized with an IEEE 802.11 wireless access point. In practice, the communication station 110 and an access point may be co-located in substantially the same location.

Each of the communication station 110 and the access points 120-170 may be coupled with one another through an appropriate network (not shown in FIG. 1). The aforementioned network may be realized with one or more wired networks and/or wireless networks, and may comprise one or more backhaul networks, one or more core networks, one or more gateways, one or more servers and/or other network equipments (not shown in FIG. 1).

As descripted above, the storage device 213 of the communication station 110 is configured to operably store the target frequency list utilized for representing multiple target frequencies F1-Fn. In operations, the processor module 215 may control the transceiving circuit 211 to transmit the target frequency list and the assigned scanning order to the user equipment 102 by broadcasting the target frequency list and the assigned scanning order or by sending a dedicated message to the user equipment 102. When the first communication circuit 201 of the user equipment 102 receives the target frequency list and the assigned scanning order transmitted from the transceiving circuit 211, the control circuit 207 may control the second communication circuit 203 to scan the multiple target frequencies F1-Fn indicated by the target frequency list in order according to the assigned scanning order to locate an available access point.

Since the target frequency list provides indication information of the target frequencies F1-Fn on which available WLANs are deployed by the operator of the communication system 100 or deployed by the partners of the operator, it is highly likely that the user equipment 102 is enabled to rapidly locate an available access point without spending unnecessary battery power to scan other frequencies not indicated in the target frequency list. In this way, the power consumption of the user equipment 102 can be significantly reduced, thereby improving the power saving performance of the user equipment 102 and extending the standby time of the user equipment 102.

In some embodiments, the storage device 213 of the communication station 110 may be further configured to operably store a scanning time limitation message, and the processor module 215 may be further configured to operably control the transceiving circuit 211 to transmit the scanning time limitation message to the first communication circuit 201 by broadcasting the scanning time limitation message or by sending a dedicated message to the user equipment 102. If a time length that the second communication circuit 203 of the user equipment 102 spends on scanning a specific target frequency of the multiple target frequencies F1-Fn reaches a maximum scanning time limit indicated by the scanning time limitation message and no access point has yet detected, the control circuit 207 may be further configured to operably control the second communication circuit 203 to instead scan another target frequency prioritized right behind the specific target frequency according to the assigned scanning order.

For example, in the previous embodiment where the first target frequency F1 is prioritized right prior to the second target frequency F2 in the assigned scanning order, if a time length that the second communication circuit 203 spends on scanning the first target frequency F1 reaches the maximum scanning time limit indicated by the scanning time limitation message and no access point has yet detected, the control circuit 207 controls the second communication circuit 203 to stop scanning the first target frequency F1 and to instead scan the second target frequency F2 prioritized right behind the first target frequency F1 according to the assigned scanning order.

Similarly, if a time length that the second communication circuit 203 spends on scanning the second target frequency F2 reaches the maximum scanning time limit and no access point has yet detected, the control circuit 207 controls the second communication circuit 203 to stop scanning the second target frequency F2 and to instead scan another target frequency prioritized right behind the second target frequency F2 according to the assigned scanning order.

Since the time length that the user equipment 102 can spend on scanning each of the multiple target frequencies is restricted by the maximum scanning time limit indicated by the scanning time limitation message, the user equipment 102 is thus avoided from spending too much time on scanning respective target frequency, thereby greatly increasing the efficiency of the user equipment 102 in locating an available access point.

In practice, the maximum scanning time limit may be represented in the form of a maximum length of beacon interval. In this situation, the processor module 215 may control the transceiving circuit 211 to broadcast a message indicating the maximum length of beacon interval or to send a dedicated message indicating the maximum length of beacon interval to the user equipment 102.

Once the second communication circuit 203 of the user equipment 102 locates a specific access point when scanning a specific target frequency, the control circuit 207 controls the second communication circuit 203 to establish a wireless link between the user equipment 102 and the specific access point.

For example, once the second communication circuit 203 of the user equipment 102 locates the access point 120 when scanning the second target frequency F2, the control circuit 207 controls the second communication circuit 203 to establish a wireless link between the user equipment 102 and the access point 120.

In some embodiments, when a signal quality of the access point 120 is lower than a predetermined quality level, the control circuit 207 may be further configured to operably control the second communication circuit 203 to scan other target frequencies prioritized behind the second target frequency F2 in the multiple target frequencies in order according to the assigned scanning order to locate another available access point. As a result, it may present the user equipment 102 from keeping communicating with an access point having poor signal quality.

As descripted previously, the AP memory of a specific access point in the communication system 100 may store a substitutable frequency indication message utilized for representing one or more substitutable frequencies on which some other available WLANs are deployed, and the processing circuit of that specific access point may control the transmission circuit of the specific access point to transmit the substitutable frequency indication message to the second communication circuit 203 of the user equipment 102 if a wireless link between the user equipment 102 and the specific access point is established.

For example, the AP memory 223 of the access point 120 may store a substitutable frequency indication message utilized for representing one or more substitutable frequencies on which some other available WLANs are deployed, and the processing circuit 225 of the access point 120 may control the transmission circuit 221 to transmit the substitutable frequency indication message to the second communication circuit 203 of the user equipment 102 if a wireless link between the user equipment 102 and the access point 120 is established. In this situation, when a signal quality of the access point 120 is lower than the predetermined quality level, the control circuit 207 may be further configured to operably control the second communication circuit 203 to scan the one or more substitutable frequencies indicated by the substitutable frequency indication message to locate another available WLAN (e.g., the WLAN controlled by the nearby access point 130 or the WLAN controlled by the nearby access point 140). Similarly, this approach may present the user equipment 102 from keeping communicating with an access point having poor signal quality.

In one embodiment where the access point 120 supports dual-band operations, the one or more substitutable frequencies specified in the substitutable frequency indication message may include another frequency supported by the access point 120. In this situation, the user equipment 102 is enabled to switch to another frequency supported by the access point 120 when the access point 120 supports dual-band operations.

In practice, the processing circuit 225 of the access point 120 may insert the substitutable frequency indication message into one or more beacon frames, and control the transmission circuit 221 to transmit the one or more beacon frames to the second communication circuit 203. In this way, there is no need to define additional dedicated message utilizing for indicating the substitutable frequencies.

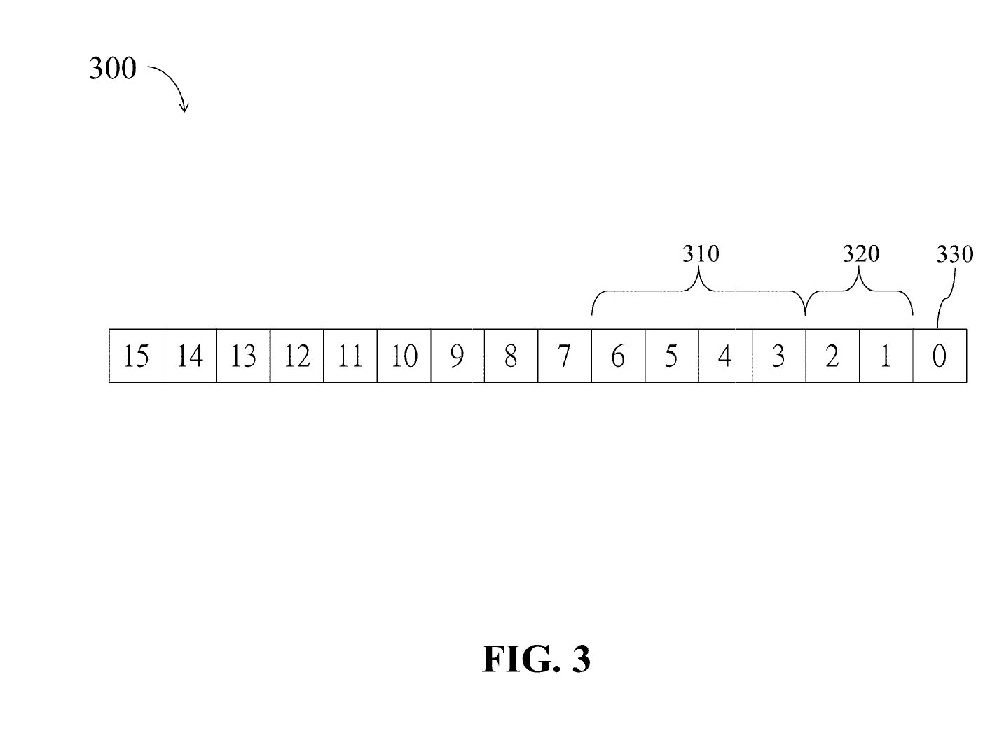

For example, FIG. 3 shows a simplified schematic diagram of a beacon frame 300 containing the substitutable frequency indication message generated by the access point 120 according to one embodiment of the present disclosure.

According to 802.11, there are 2 octets in the beacon frame 300 indicating the length of beacon interval. These 2 octets are used to indicate other channel frequencies as well. In one embodiment, the substitutable frequency indication message comprises a frequency indicator and a band indicator. The frequency indicator is utilized for indicating that another WLAN is available nearby the second target frequency F2 on which the access point 120 is deployed. The band indicator is utilized for indicating which band the frequency indicator refers to. For example, the band can be 2.4G, 3.6G, and 4.9/5G.

As shown in FIG. 3, the processing circuit 225 inserts the frequency indicator into a frequency indicator field 310 within the beacon frame 300, and inserts the band indicator into a band indicator field 320 within the beacon frame 300. The length of the frequency indicator field 310 can vary with band indicator recorded in the band indicator field 320. For example, in the case where the band indicated by the band indicator is 2.4G or 3.6G, the length of the frequency indicator field 310 is 4 bits. In the case where the band indicated by the band indicator is 4.9/5G, the length of the frequency indicator field 310 is 5 bits.

If the processing circuit 225 inserts the substitutable frequency indication message into multiple beacon frames, the processing circuit 225 may insert a message ending indicator into a message ending indicator field 330 within the beacon frame 300. For example, if the next beacon frame is also utilized by the processing circuit 225 to carry another portion of the substitutable frequency indication message, the processing circuit 225 may insert a corresponding message ending indicator (such as 1) into the message ending indicator field 330.

In some embodiments, the processor module 215 may simply specify a beginning frequency index, an ending frequency index, and an index difference between adjacent target frequencies in the target frequency list. That is, the target frequency list may be represented in the form of a combination of the beginning frequency index, the ending frequency index, and the index difference between adjacent target frequencies. In this situation, an index order of the multiple target frequencies derived from the target frequency list also indicates the assigned scanning order. That is, the assigned scanning order is represented in the form of the index order of the multiple target frequencies.

For example, at the 2.4G band, there are total of 14 frequencies, and the operator of the communication system 100 may respectively assign 14 sequential indexes to the 14 frequencies.

In one embodiment, the operator of the communication system 100 may respectively assign indexes 1-14 to the 14 frequencies based on the magnitudes of the 14 frequencies. For example, the operator of the communication system 100 may assign the index 1 to the lowest frequency and assign the index 14 to the highest frequency.

In practice, the operator of the communication system 100 may deploy WLANs on only some of the 14 frequencies. For example, the operator of the communication system 100 may deploy WLANs on only the frequencies corresponding to indexes 1, 3, 5, 7, 9, and 11. In this situation, the processor module 215 may simply specify the beginning frequency index 1, the ending frequency index 11, and an index difference between adjacent target frequencies (i.e., 2 in this case) in the target frequency list. When the user equipment 102 receives the target frequency list transmitted from the communication station 110, the control circuit 207 of the user equipment 102 derives all effective frequency indexes based on the information specified in the target frequency list, and converts the resulting effective frequency indexes into multiple target frequencies. In this embodiment, the control circuit 207 would obtain that the target frequencies indicated by the target frequency list are the frequencies corresponding to indexes 1, 3, 5, 7, 9, and 11. Then, the control circuit 207 would control the second communication circuit 203 to scan the frequencies corresponding to indexes 1, 3, 5, 7, 9, and 11 in order according to the assigned scanning order (i.e., the index order of the multiple target frequencies).

In some embodiments, the processor module 215 may simply sort the multiple target frequencies in the target frequency list in order according to magnitudes of the multiple target frequencies and utilizes a sorting order of the multiple target frequencies to be the assigned scanning order. That is, the assigned scanning order is represented in the form of a sorting order of the multiple target frequencies in the target frequency list.

When the user equipment 102 receives the target frequency list transmitted from the communication station 110, the control circuit 207 of the user equipment 102 controls the second communication circuit 203 to scan the multiple target frequencies in the target frequency list in order according to the sorting order of the multiple target frequencies in the target frequency list.

As can be appreciated from the forgoing descriptions, the target frequency list transmitted from the communication station 110 to the user equipment 102 provides indication information of the target frequencies F1-Fn on which available WLANs are deployed by the operator of the communication system 100 or deployed by the partners of the operator. Therefore, the user equipment 102 is enabled to rapidly locate an available access point without spending unnecessary battery power to scan other frequencies not indicated in the target frequency list. In this way, the power consumption of the user equipment 102 can be significantly reduced, thereby improving the power saving performance of the user equipment 102 and extending the standby time of the user equipment 102.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled with,” “couples with,” and “coupling with” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A communication system, comprising:
a communication station, comprising:
a transceiving circuit configured to operably transmit signal by utilizing a first radio access technology (RAT);
a storage device configured to operably store a target frequency list, wherein the target frequency list is utilized for representing multiple target frequencies comprising a first target frequency and a second target frequency; and
a processor module, coupled with the transceiving circuit and the storage device, configured to operably control the transceiving circuit to transmit the target frequency list and an assigned scanning order, wherein the assigned scanning order prioritizes the first target frequency to be right prior to the second target frequency;
multiple access points comprising a first access point; and
a user equipment, comprising:
a first communication circuit configured to operably receive the target frequency list and the assigned scanning order transmitted from the transceiving circuit by utilizing the first RAT;
a second communication circuit configured to operably communicate with other devices by utilizing a second RAT different from the first RAT;
a memory device configured to operably store the target frequency list and the assigned scanning order received by the first communication circuit; and
a control circuit, coupled with the first communication circuit, the second communication circuit, and the memory device, configured to operably control the second communication circuit to scan the multiple target frequencies in order according to the assigned scanning order to locate an available access point.

2. The communication system of claim 1, wherein the storage device is further configured to operably store a scanning time limitation message, and the processor module is configured to operably control the transceiving circuit to transmit the scanning time limitation message to the first communication circuit;
wherein if a time length that the second communication circuit spends on scanning the first target frequency reaches a maximum scanning time limit indicated by the scanning time limitation message and no access point has yet detected, the control circuit is further configured to operably control the second communication circuit to instead scan the second target frequency prioritized right behind the first target frequency according to the assigned scanning order.

3. The communication system of claim 2, wherein the maximum scanning time limit is represented in the form of a maximum length of beacon interval.

4. The communication system of claim 2, wherein once the second communication circuit locates the first access point when scanning the second target frequency, the control circuit controls the second communication circuit to establish a wireless link between the user equipment and the first access point;
wherein when a signal quality of the first access point is lower than a predetermined quality level, the control circuit is further configured to operably control the second communication circuit to scan other target frequencies prioritized behind the second target frequency in the multiple target frequencies in order according to the assigned scanning order to locate another available access point.

5. The communication system of claim 2, wherein once the second communication circuit locates the first access point when scanning the second target frequency, the control circuit controls the second communication circuit to establish a wireless link between the user equipment and the first access point;
wherein the first access point comprises:
a transmission circuit configured to operably communicate with the user equipment by utilizing the second RAT;
an AP memory configured to operably store a substitutable frequency indication message, wherein the substitutable frequency indication message is utilized for representing one or more substitutable frequencies on which some available WLANs are deployed; and
a processing circuit, coupled with the transmission circuit and the AP memory, configured to operably control the transmission circuit to transmit the substitutable frequency indication message to the second communication circuit;
wherein when a signal quality of the first access point is lower than a predetermined quality level, the control circuit is further configured to operably control the second communication circuit to scan the one or more substitutable frequencies to locate another available access point.

6. The communication system of claim 5, wherein the processing circuit inserts the substitutable frequency indication message into one or more beacon frames, and controls the transmission circuit to transmit the one or more beacon frames to the second communication circuit.

7. The communication system of claim 6, wherein the substitutable frequency indication message comprises a frequency indicator and a band indicator and, wherein the frequency indicators indicates that another WLAN is available nearby the second target frequency, and the band indicator indicates which band the frequency indicator refers to.

8. The communication system of claim 1, wherein once the second communication circuit locates the first access point when scanning the second target frequency, the control circuit controls the second communication circuit to establish a wireless link between the user equipment and the first access point;
wherein when a signal quality of the first access point is lower than a predetermined quality level, the control circuit is further configured to operably control the second communication circuit to scan other target frequencies prioritized behind the second target frequency in the multiple target frequencies in order according to the assigned scanning order to locate another available access point.

9. The communication system of claim 1, wherein once the second communication circuit locates the first access point when scanning the second target frequency, the control circuit controls the second communication circuit to establish a wireless link between the user equipment and the first access point;
wherein the first access point comprises:
a transmission circuit configured to operably communicate with the user equipment by utilizing the second RAT;
an AP memory configured to operably store a substitutable frequency indication message, wherein the substitutable frequency indication message is utilized for representing one or more substitutable frequencies on which some available WLANs are deployed; and
a processing circuit, coupled with the transmission circuit and the AP memory, configured to operably control the transmission circuit to transmit the substitutable frequency indication message to the second communication circuit;
wherein when a signal quality of the first access point is lower than a predetermined quality level, the control circuit is further configured to operably control the second communication circuit to scan the one or more substitutable frequencies to locate another available access point.

10. The communication system of claim 9, wherein the processing circuit inserts the substitutable frequency indication message into one or more beacon frames, and controls the transmission circuit to transmit the one or more beacon frames to the second communication circuit.

11. The communication system of claim 10, wherein the substitutable frequency indication message comprises a frequency indicator and a band indicator and, wherein the frequency indicators indicates that another WLAN is available nearby the second target frequency, and the band indicator indicates which band the frequency indicator refers to.

12. The communication system of claim 1, wherein the target frequency list is represented in the form of a combination of a beginning frequency index, an ending frequency index, and an index difference between adjacent target frequencies, and the assigned scanning order is represented in the form of an index order of the multiple target frequencies.

13. The communication system of claim 1, wherein the processor module is further configured to operably sort the multiple target frequencies in the target frequency list in order according to magnitudes of the multiple target frequencies, and the assigned scanning order is represented in the form of a sorting order of the multiple target frequencies in the target frequency list.

14. A communication station of a communication system, wherein the communication system comprises multiple access points and a user equipment, the communication station comprising:
a transceiving circuit configured to operably transmit signal by utilizing a first radio access technology (RAT);
a storage device configured to operably store a target frequency list, wherein the target frequency list is utilized for representing multiple target frequencies comprising a first target frequency and a second target frequency; and
a processor module, coupled with the transceiving circuit and the storage device, configured to operably control the transceiving circuit to transmit the target frequency list and an assigned scanning order to the user equipment to enable the user equipment to scan the multiple target frequencies in order according to the assigned scanning order to locate an available access point;
wherein the assigned scanning order prioritizes the first target frequency to be right prior to the second target frequency.

15. The communication station of claim 14, wherein the storage device is further configured to operably store a scanning time limitation message, and the processor module is configured to operably control the transceiving circuit to transmit the scanning time limitation message to the first communication circuit;
wherein if a time length that the user equipment spends on scanning the first target frequency reaches a maximum scanning time limit indicated by the scanning time limitation message and no access point has yet detected, the user equipment instead scans the second target frequency prioritized right behind the first target frequency according to the assigned scanning order.

16. The communication station of claim 15, wherein the maximum scanning time limit is represented in the form of a maximum length of beacon interval.

17. The communication station of claim 14, wherein the target frequency list is represented in the form of a combination of a beginning frequency index, an ending frequency index, and an index difference between adjacent target frequencies, and the assigned scanning order is represented in the form of an index order of the multiple target frequencies.

18. The communication station of claim 14, wherein the processor module is further configured to operably sort the multiple target frequencies in the target frequency list in order according to magnitudes of the multiple target frequencies, and the assigned scanning order is represented in the form of a sorting order of the multiple target frequencies in the target frequency list.

19. A user equipment of a communication system, wherein the communication system comprises a communication station and multiple access points, the user equipment comprising:
a first communication circuit configured to operably receive a target frequency list and an assigned scanning order transmitted from the communication station by utilizing a first radio access technology (RAT), wherein the target frequency list is utilized for representing multiple target frequencies comprising a first target frequency and a second target frequency, and the assigned scanning order prioritizes the first target frequency to be right prior to the second target frequency;
a second communication circuit configured to operably communicate with other devices by utilizing a second RAT different from the first RAT;
a memory device configured to operably store the target frequency list and the assigned scanning order received by the first communication circuit; and
a control circuit, coupled with the first communication circuit, the second communication circuit, and the memory device, configured to operably control the second communication circuit to scan the multiple target frequencies in order according to the assigned scanning order to locate an available access point.

20. The user equipment of claim 19, wherein the first communication circuit is further configured to operably receive a scanning time limitation message transmitted from the communication station:
wherein if a time length that the second communication circuit spends on scanning the first target frequency reaches a maximum scanning time limit indicated by the scanning time limitation message and no access point has yet detected, the control circuit is further configured to operably control the second communication circuit to instead scan the second target frequency prioritized right behind the first target frequency according to the assigned scanning order.

21. The user equipment of claim 20, wherein the maximum scanning time limit is represented in the form of a maximum length of beacon interval.

22. The user equipment of claim 20, wherein once the second communication circuit locates the first access point when scanning the second target frequency, the control circuit controls the second communication circuit to establish a wireless link between the user equipment and the first access point;
wherein when a signal quality of the first access point is lower than a predetermined quality level, the control circuit is further configured to operably control the second communication circuit to scan other target frequencies prioritized behind the second target frequency in the multiple target frequencies in order according to the assigned scanning order to locate another available access point.

23. The user equipment of claim 20, wherein once the second communication circuit locates the first access point when scanning the second target frequency, the control circuit controls the second communication circuit to establish a wireless link between the user equipment and the first access point;
wherein the second communication circuit is further configured to operably receive a substitutable frequency indication message transmitted from the first access point, wherein the substitutable frequency indication message is utilized for representing one or more substitutable frequencies on which some available WLANs are deployed;
wherein when a signal quality of the first access point is lower than a predetermined quality level, the control circuit is further configured to operably control the second communication circuit to scan the one or more substitutable frequencies to locate another available access point.

24. The user equipment of claim 23, wherein the substitutable frequency indication message is contained in one or more beacon frames.

25. The user equipment of claim 24, wherein the substitutable frequency indication message comprises a frequency indicator and a band indicator and, wherein the frequency indicators indicates that another WLAN is available nearby the second target frequency, and the band indicator indicates which band the frequency indicator refers to.

26. The user equipment of claim 19, wherein once the second communication circuit locates the first access point when scanning the second target frequency, the control circuit controls the second communication circuit to establish a wireless link between the user equipment and the first access point;
wherein when a signal quality of the first access point is lower than a predetermined quality level, the control circuit is further configured to operably control the second communication circuit to scan other target frequencies prioritized behind the second target frequency in the multiple target frequencies in order according to the assigned scanning order to locate another available access point.

27. The user equipment of claim 19, wherein once the second communication circuit locates the first access point when scanning the second target frequency, the control circuit controls the second communication circuit to establish a wireless link between the user equipment and the first access point;
wherein the second communication circuit is further configured to operably receive a substitutable frequency indication message transmitted from the first access point, wherein the substitutable frequency indication message is utilized for representing one or more substitutable frequencies on which some available WLANs are deployed;
wherein when a signal quality of the first access point is lower than a predetermined quality level, the control circuit is further configured to operably control the second communication circuit to scan the one or more substitutable frequencies to locate another available access point.

28. The user equipment of claim 27, wherein the substitutable frequency indication message is contained in one or more beacon frames.

29. The user equipment of claim 28, wherein the substitutable frequency indication message comprises a frequency indicator and a band indicator and, wherein the frequency indicators indicates that another WLAN is available nearby the second target frequency, and the band indicator indicates which band the frequency indicator refers to.

30. The user equipment of claim 19, wherein the target frequency list is represented in the form of a combination of a beginning frequency index, an ending frequency index, and an index difference between adjacent target frequencies, and the assigned scanning order is represented in the form of an index order of the multiple target frequencies.

31. The user equipment of claim 19, wherein the multiple target frequencies are sorted in the target frequency list in order according to magnitudes of the multiple target frequencies, and the assigned scanning order is represented in the form of a sorting order of the multiple target frequencies in the target frequency list.
